(19) United States
(12) Patent Application Publication
(10) Pub. No.: US 2013/0238893 A1
(43) Pub. Date: Sep. 12, 2013

(54) DIGITAL LOCKER FOR ESTATE PLANNING SYSTEM AND METHOD

(71) Applicant: Joseph F. Henderson, St. Paul, MN (US)

(72) Inventor: Joseph F. Henderson, St. Paul, MN (US)

(73) Assignee: FYI WHEN I DIE, LLC, Minneapolis, MN (US)

(21) Appl. No.: 13/417,391

(22) Filed: Mar. 12, 2012

(51) Int. Cl. H04L 29/06

(52) U.S. Cl. 713/155

(57) ABSTRACT

A secure system and method is presented for an individual to gather, organize, store, and share personal and asset information. The system is offered through software-as-service platform to professional service providers who provide the platform as a service for their clients as a complement to their traditional service offerings. The client uses the system as tool to provide information to his or her professional service provider. In addition, the client uses the system to gather, organize, store, and share personal information with others. This information can be shared at the time of the client's choosing, or at the client's death. The service provider assists the recipients in accessing the information by providing the verification point of a triggering event.

### FIELD OF THE INVENTION

The present application relates to the field of data storage, communication, and data release. More particularly, the described embodiments relate to a system and method for storing and releasing estate planning documents and related records over a world wide communication network, and associating that system with one or more estate planning or financial professionals.

### BACKGROUND

Throughout history, when somebody dies, a wealth of important information goes with them. Even seemingly well-organized people often leave loved ones scratching their heads in a desperate search for information and assets. In our digital age, with more and more information moving online and being stored electronically, increasing amounts of it are becoming permanently inaccessible for failure of the deceased to have provided another person with means for its retrieval. Gone are the days when we could locate every person's assets by simply checking their safe, mailbox, desk, and dresser drawers. Barring an alternative, some organized people keep a master list of important assets and information and store it with their will or on a computer. But when these things are stored in a place that is accessible, there is a danger that the correct people do not find the list at the appropriate time.

A growing need exists and new tools are available to address this need in a comprehensive and efficient manner. Published U.S. Patent Application No. 2002 /0111946 addresses this issue in a general matter, but fails to integrate the system into the offerings, services, or products of traditional service providers in this area. The system described herein gives service professionals and their clients the ability to efficiently and effectively gather, organize, store and share personal and asset information in a logical and secure manner.

### SUMMARY

The invention gives the professional services provider a means to easily address these needs to the benefit of both the client and the services provider. The client is already turning to the professional for planning and organizational services. The professional service provider compliments his or her traditional services by providing each client with access to a personal online profile where the client can collect, organize, and store a broad variety of important private information. This information may include confidential information, such as account numbers and passwords for on-line accounts. The invention is designed to serve as both an intake tool for the professional services provider as well as a self-managed digital profile for the client. As the service professional adds clients, she simply creates new user accounts and instructs her clients to access their profiles through a provided link. One embodiment of the invention can be branded with the service professional's own logo, look and feel—thereby becoming a natural extension of the service provider's own offerings.

As the client enters information into his profile, he also designates which recipients should have access to that information and when. While the professional services provider gets default access to the intake information, the client retains exclusive control over the variety of information contained in his profile and can continue using the tool to organize, store and share information with loved ones. The client receives regular email reminders from the professional services provider asking him to keep his profile updated; while each recipient receives regular email reminders asking them to contact the professional services provider if a triggering event occurs. The client even has the ability to download his profile information into electronic printable form to store or share as he chooses.

Once the client dies, the professional services provider is relied upon to activate the post-mortem access to information and to make sure each information recipient is able to access those pieces of information preselected by the client. The professional services provider is a key player in the delivery of the service benefits; and if any information recipient fails to access the preselected information, the professional services provider can attempt to contact that person to ensure proper delivery.

### BRIEF DESCRIPTION OF THE DRAWINGS

FIG. 1 is a schematic diagram showing a plurality of users interacting with a computerized system implementing one embodiment of the present invention.

FIG. 2 is a schematic drawing showing the elements of the computers, components, and data elements utilized to implement the computerized system.

FIG. 3 is a flow chart showing a method implementing one embodiment of the present invention.

FIG. 4 is a schematic drawing showing sample elements of the intake information used by the embodiment of FIG. 3.

FIG. 5 is a schematic drawing showing sample elements of the digital profile sued by the embodiment of FIG. 3.

### DETAILED DESCRIPTION

### Overview of the System

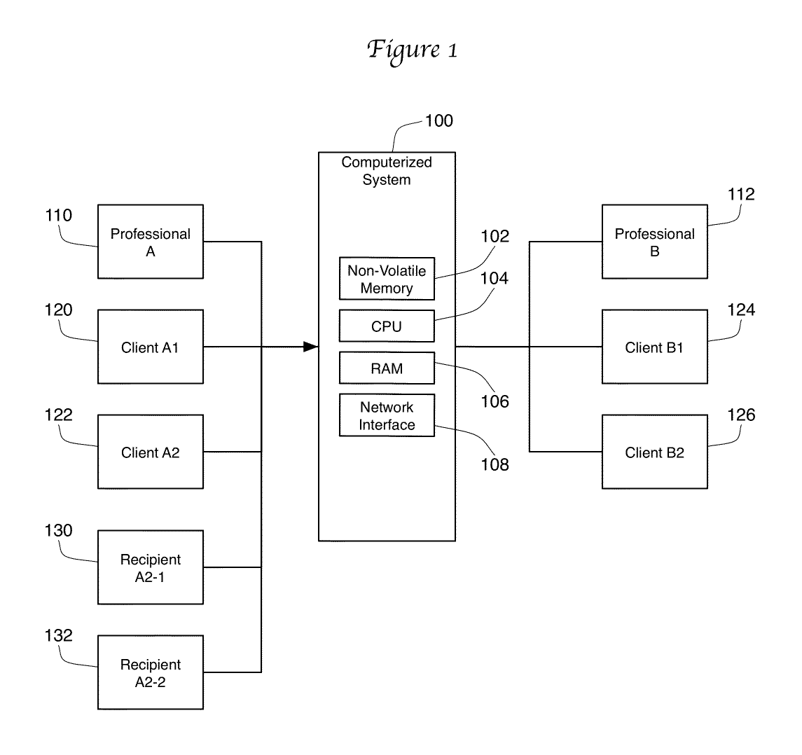

FIG. 1 is a block diagram showing a plurality of professionals 110, 112, their clients 120-126, and the related recipients 130, 132 that are interconnected through a computerized system 100. The computerized system 100 provides an interactive interface to users 110-132 that allows users 110-132 to store, recall, and share data in the computerized system 100. In the present description, professionals 110-112 are professional service providers such as estate planning attorneys, financial planners, accountants, insurance agents, or human resource providers that provide access to the computerized system 100 to their clients 120-126. This access is provided as a complement to the traditional service offerings of these professionals 110, 112. The clients 120-126 in the present description are the clients of professionals 110-112 who are granted access to the computerized system by working with those professionals 110-112. In FIG. 1, client A1 120 and client A2 122 are so labeled because they access the system 100 through their relationship with professional A 110, while clients B1 124 and client B2 126 are so labeled because they access the system 100 through their relationship with professional B 112. The recipients 130, 132 are those individuals that have been designated by the clients 120-126 to receive access to the data stored in the computerized system 100. In FIG. 1, both recipients 130, 132 are designated recipients of client A2 122, as indicated by labeling the recipients 130, 132 as A2-1 and A2-2, respectively.

The computerized system 100 includes a set of software instructions or interfaces stored on a non-volatile, non-transitory, computer readable medium 102, which may take the form of a computer hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile, RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

The professionals 110, 112, initiate use of the system 100 by customizing the interface that will be seen by themselves, their clients 120-126, and the related recipients 130-132. In certain embodiments of the invention, the service will be offered to the professionals 110, 112 as a white label service, allowing the professional 110, 112 to brand the service with his or her own trade dress and thereby more readily integrate the service with their existing service offerings. Thus when clients A1 120 and A2 122 access the system 100, the interface will reflect the trade dress, logos, and identity of professional A 110, while clients B1 124 and B2 126 will see the trade dress, logos, and identity of professional B 112 whenever they access the system 110.

After customizing the interface for their clients 120-126, the professionals 110, 112 instruct their clients 120-126 to access the computerized system in order to input personal information into the system. The professional 110, 112 can then use this information to provide their traditional services (e.g., estate planning services for an estate planning attorney, or accounting services for an accountant). The client's personal data is preferably collected through a library of interactive forms. This library of forms is provided by the white label service of the entity that operates the computerized system 100. For example, this allows a new estate planning attorney that wishes to use the system 100 to have immediate access to standard customer forms that have been designed for estate planning attorney clients, while a new accountant would be able to use standard forms designed for accounting clients. Each professional 110, 112 can select the forms that they desire for their business, and, in one embodiment, then customize those forms as he or she desires. When the client 120-126 accesses the system 100, the clients 120-126 will see the customized forms selected by their professional 110, 112. When the client 120-126 has entered information into the selected forms, the professional 110, 112 will be able to access that information.

The information collected from the client is securely stored in the client's personal digital profile stored on the non-volatile memory 102 of the computerized system 100. The client 120-126 has the ability to augment the information in their digital profile beyond the scope of information needed by the service professional 110-112. The computerized system 100 grants default access to the service provider 110-112 to only to those pieces of information needed for the provision of the professional services. In one embodiment, the client controls all access to their data in the digital profile, and even has the ability to change the default access provided to their service professional 110-112. In fact, each time information or content is added, the client 120-126 may decide who gets access to that piece of information or content and when that person or persons get access.

The client 120-126 also designates one or more recipients 130-132 that receive conditional access to their digital profile. These recipients are always associated with a particular client 120-126, as recipients A2-1 130 and A2-2 are associated with client A2 122. The computerized system 100 grants the recipients 130-132 access to some or all of the digital profile of their associated client 122 upon the occurrence of a triggering event, such as the disability or death of the client 122, or upon a specific date. In one embodiment, if the client 122 fails to specify any other trigger, the computerized system 100 will grant access to the entire digital profile to the recipients upon the death of the client 122 but not before.

For each recipient 130, 132 identified by the client 122, an email is sent to that recipient 130, 132 asking them to register with the computerized system 100 so that they can gain access to the digital profile when that information is made available. The system 100 generates regular emails to the client 122 to remind the client 122 to keep the information in their digital profile up to date. The system 100 also generates regular emails to the recipients 130, 132 to remind the recipients 130, 132 to keep the information in their digital profile up to date and to inform them that they should contact the service professional 110 upon the occurrence of a triggering event. Recipients 130, 132 are only granted access to their designated information after the service professional 110 has confirmed the triggering event and subsequently enabled access to the recipient 130, 132 on behalf of the client 122.

### Implementation as a Web Server

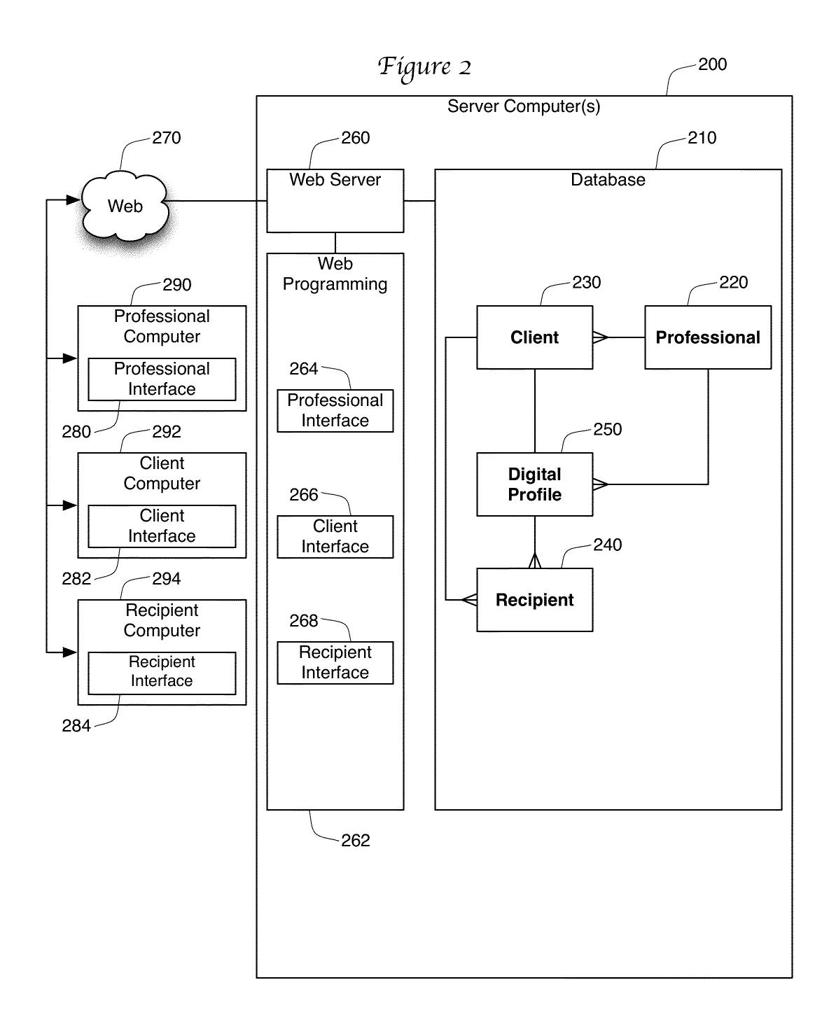

The computerized system 100 of FIG. 1 can be implemented as one or more web server computers 200 as shown in FIG. 2. The server computer 200 is capable of storing information about all of the parties that use the system 100 that were described above in connection with FIG. 1. In the preferred embodiment, a server computer 200 stores this information in a database 210. This information can be maintained as separate tables in a relational database, or as database objects in an object-oriented database environment within the database 210. FIG. 2 shows the database 210 with tables or objects for professionals 220, clients 230, and recipients 240. This allows the database 210 to maintain information about the professionals 110-112, clients 120-126, and recipients 130-132 that may access the server computer 200. In addition, the database 210 stores data of relevance to the client 230 in a digital profile database entity 250.

Of course, the table or object entities shown in FIG. 2 should not be considered to show actual implementation details of the database 210, since it is well within the scope of the invention to implement this type of data using a variety of entity architectures. The entities shown are exemplary, intended only to aid in the understanding of the data maintained by the database 210 in this embodiment. For example, it would be well within the scope of the present invention to divide information about professionals 220 into multiple tables or objects, instead of the single professional database entity 220 shown in FIG. 2. Similarly, it would be possible to implement the database 210 such that information about professionals, clients, and recipients all use a single database table or object, where the role (professional, client, or recipient) for each instance is defined using a field within that table or object. Finally, it is not even necessary to implement these entities as formal tables or objects, as other database paradigms could also effectively implement these types of data structures.

Relationships between these entities 220-250 are represented in FIG. 2 using crow's foot notation. For example, FIG. 2 shows that each client 230 is associated through database links with a single professional 220, while a professional 220 may be associated with multiple clients 230. Relationships in the database 210 can be established through any standard technique for associating, connecting, linking, or otherwise establishing relationships between database entities within a database. From FIG. 2, it can be seen that each client 230 may have multiple recipients 240, but each recipient 240 is linked with only a single client 230. Furthermore, we know that each client 230 and each recipient are linked with only a single digital profile record 250, while professionals 220 that work with many clients 230 will be associated with multiple profile records 250.

The database 210 is used by a web server 260 operating on one or more of the server computers 200 to generate the various interfaces used by the system 100. In particular, web programming 262 exists that defines how to create a professional interface 264, a client interface 266, and a recipient interface 268 using the data in the database 210. This programming 262 allows the web server 260 to transmit over the World Wide Web 270 (or similar wide area network) a professional interface 280 that can be seen by a browser operating on a computer 290 for the benefit of a professional 110, 112. Similarly, the web server 260 can manage a client interface 282 on browser operating on a client computer 292, and a recipient interface 284 operating on a recipient computer 294. Each computer 200, 290, 292, 294 could be a standard personal computer operating a Microsoft Windows, Linux, or Apple Mac OS operating system. Alternatively, some of these computers, such as 290-294, could be mobile devices, such as smart phones or tablet computers, operating Google Android, Apple iOS, or Microsoft Windows Phone operation system. In addition, these devices 290-296 could be a “smart” or Internet enabled television sets.

### Professional Service Provider Set-Up Interaction

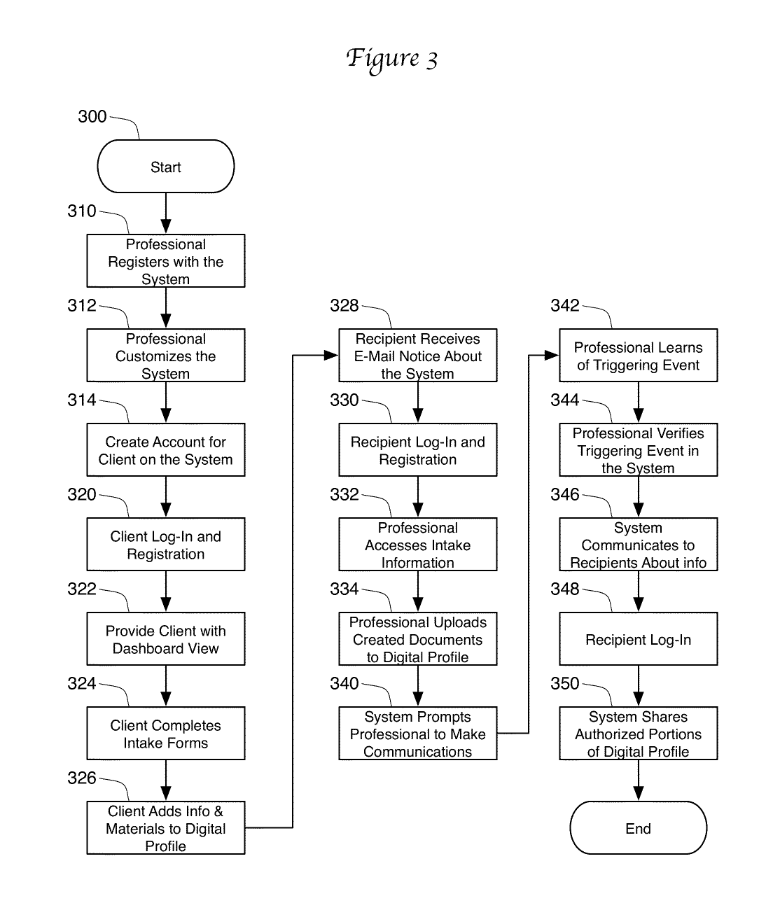

FIG. 3 is a flow chart showing the process 300 by which the users 110-132 utilize the computerized system 10. For the sake of simplicity, this description will focus on the use of the system 100 by a single professional A 110 and their client A2 122, who shares his digital profile with recipient A2-1 130. This description should not be considered limiting, as the intent of the present invention is to have the system 100 be utilized by numerous professionals 110, 112, with each professional 110, 112 having a plurality of clients 120-126, and with each client 120-126 designating a plurality of recipients 130, 132.

In the first step 310 of process 300, the professional services provider 110 registers herself with the computerized system 100. This step must be taken before the professional 110 may offer the product's services to her clients 120, 122. Registration includes basic address and contact information as well as the creation of login credentials (user name, password and security questions). These login credentials are requested by the system 100 every time a user accesses the system in order to identify and authenticate individual users.

At step 312, the professional services provider 110 will use administrative tools available through the professional interface 280 to customize her experience with the system 100 as well as the experience of her client 122. Professional 110 integrates the system 100 either by using her own custom domain (i.e., Internet domain name address) or through use of the system domain controlled by the entity that operates system 100. If a custom domain is used, the client 122 will be directed to a sub-domain of the professional's existing domain. The professional 110 creates this sub-domain and then redirects the sub-domain to an address provided by the operator of system 100. The professional 110 has the opportunity to customize the landing page first viewed by her client 122 with her firm's logo and contact information. If the system domain is used, the client 122 is directed to the professional's landing page on the system's server 200. The professional 110 also has the opportunity to customize this landing page with their firm logo and contact information.

The customization of step 312 also includes the creation and modification of the intake questionnaires that the system 100 provides to client 122. By so doing, the professional 110 is also defining the intake data that the system 100 will track in the client's digital profile 250. The intake forms will be provided to the client 122 through that client's client interface 282. These forms will use best-practice data collection techniques appropriate for the professional services provider 110. However, the system 100 will also support a diversity of business practices and sensitivity. The system's form engine will enable professional services providers 110 to add, edit, or exclude most form elements according to the needs of their practice. In step 312, the professional 110 can also customize other elements of their implementation of the computerized system 100, including the introduction language, fonts, colors, graphics (including company logo), messages, contact information, and the body and subject of email messages that are sent to the client 122 and the recipient 130.

In one embodiment, the professional services provider 110 is responsible for the creation of accounts on the computerized system 100 for each of her customers 120, 122. This occurs at step 314. The professional 110 creates a new account for her client 122 using minimal information known about the client, such as their name, contact information and email address. In the case of couples, a tied pair of accounts is created. The professional services provider 110 also provides payment to the manager of the computerized system 100 during account creation. Payment information can be remembered at the discretion of the professional services provider 110 to simplify subsequent account creation. With the creation of a new account, an email with a temporary password is sent to the client 122 inviting him to visit the system site (through client interface 282) to begin the intake process.

In an alternative embodiment, the computerized system 100 can allow client 122 to create his own account on the system 100. Because every new client account must be associated with a professional 110, the account creation process requires any client that creates their own account to identify and associate themselves with a professional 110 that uses the system 100. This alternative embodiment allows a professional 110 to explain to new clients that they must create an account on the system 100 before their first meeting. The professional 110 would provide instructions on how to create the account to new customers, ensuring that the appropriate intake data would be entered into the system before their first meeting. In one embodiment, the system 100 would allow new accounts to be created by client 120 before payment, but would require payment by the professional 110 before information in a client's digital profile 250 is shared with the professional 110.

Client Interaction with the System.

Upon his first actual use of the system 100, the client 122 is asked to create a permanent password (i.e., login credentials) as well as security questions and answers that can be used to retrieve a lost or forgotten password. This registration process takes place in step 320.

Once the user is logged into their account, the system 100 at step 322 provides the client 122 with a dashboard, which is the home page for the client within the system 100 and provides a summary of client's account status. The dashboard includes a visual indication of overall percentage to which the client's digital profile 250 is complete, warnings about recommended actions, and a messaging tool to display and create messages between the client 122 and their professional services provider 110. The dashboard also includes other information including space for the professional services provider 110 to populate with selected articles, information, static image or message or system default information.

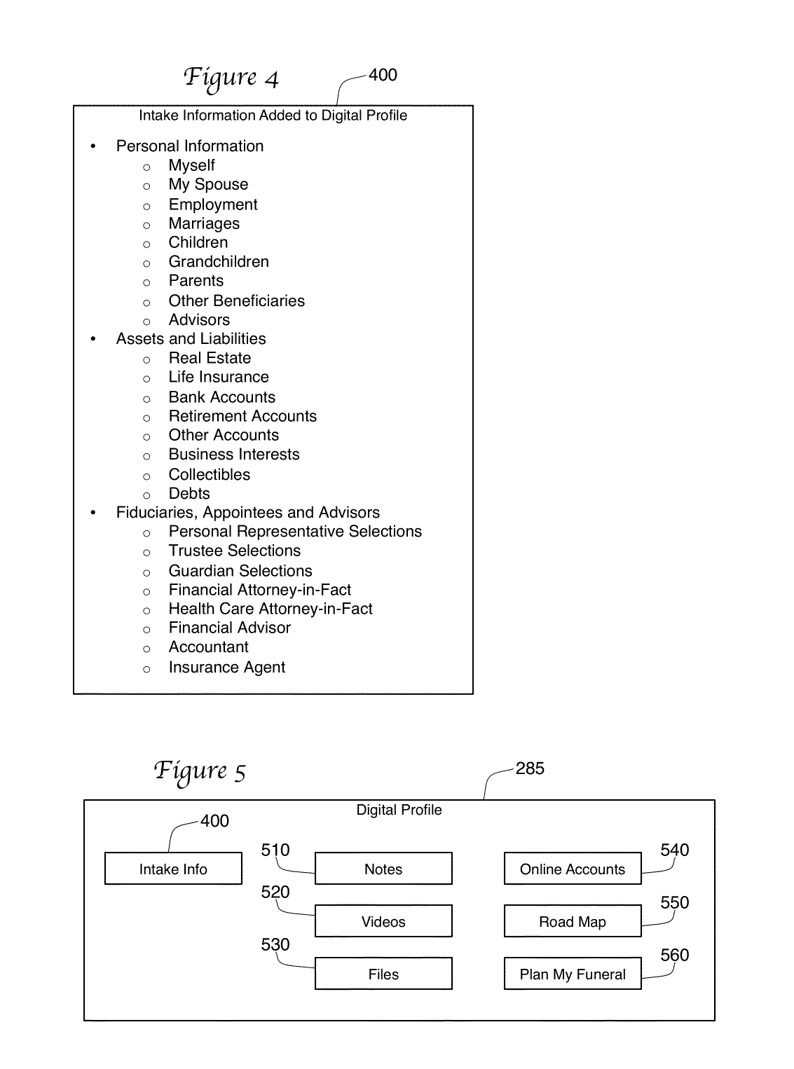

One of the primary purposes of the client interface 282 is to allow the client 122 to input data into their digital profile. This intake of information takes place at step 324, and utilizes several forms designed to collect the information needed to create the client's profile. The intake information entered at this intake step 324 is stored in the digital profile 250. The intake information is the type of information that would be useful for the professional 110 to perform her standard services for the client 122 and for recipients to have following the client's death or disability. For example, with respect to estate planning professionals, intake information includes those items 400 indicated on FIG. 4. All forms used by the client interface 282 for data input into the digital profile 250 intelligently expand and contract according to the client's answers thereby streamlining the data entry process. All forms provide appropriate validation and input helpers to help ensure accurate information. Professional services providers 110 can customize all forms for receiving intake information 400 according to the diversity and sensitivities of their individual practice using a forms editor. By default, the professional services provider 110 is given read-only access to the client's intake information 400 to assist in providing their professional services. In some embodiments, permission to access the intake information 400 can be changed by the client 122 as desired.

In addition to intake information 400, the client 122 at step 326 can add additional information and materials to the digital profile 250, as is shown in FIG. 5. In particular, the digital profile may include the following categories of information and materials:
Notes 510. The note form allows the client 122 create a simple unstructured message to his recipient 130. The notes 510 are as flexible and open-ended as a standard email message.
Videos 520. The video form allows the client 122 to upload and describe videos files 520.
Files 530. The file form allows the client 122 to upload and describe arbitrary digital files 530.
Online Accounts 540. The online account form allows the client 122 to identify online accounts 540 and to record the security credentials (user name, password, security questions, special instructions) needed to access them.
Road Map 550. The road map form allows the client 122 to describe the location of tangible assets and important items that exist in the real world rather than in digital format.
Plan My Funeral 560. The plan my funeral form allows the client 122 to provide notes, suggestions, ideas, or even detailed plans about the client's desires concerning their funeral service, their visitation or wake, the reception, desires regarding memorials and notifications, and their wishes with respect to burials or cremation.

Within each category 510-560 of information in the digital profile 250, the client 122 is able to create a nearly unlimited number of records. Unlike the information collected on the Intake forms 400, the information created, entered and stored in the rest of the digital profile 250 is not available to the professional services provider 110 unless explicitly granted by the client 122.

In addition, it should be noted that, in the preferred embodiment, the client 122 has ultimate control over whether and with whom to affiliate his digital profile 250. In other words, the client 122 has the ability to transfer his professional services relationship to another professional 112 so long as that professional 112 is registered with the system 100. In doing so, the information entered by the client 122 will transfer intact and the same abilities of the previous professional 110 to interact with the intake information 400 will transfer to the new professional services provider 112.

For each data entry 510-560 added to the digital profile 250, the client has the opportunity to identify one or more recipients 130, 132 of the information 510-560 that have access to that data, either immediately or upon the occurrence of some triggering event. As shown at step 328, each recipient 130, 132 identified by the client 122 will receive an email instructing her to register herself with the system 100 as a participant in the client's digital profile 250. Interaction between the recipient 130 and the system 100 will take place through the recipient interface 284, which may also include customizations specified by the professional 110 working with the client 122.

The client 122 will be notified when their recipient 130 registers with the system 100 through interface 284. During registration (step 330), the recipient 130 establishes her username and password (her login credentials) as well as secret questions and answers that can be used to retrieve a forgotten password. The client 122 will also be notified if there are their recipient 130 fails to register or if email to recipient 130 is rejected or bounces back.

### Interaction Between Clients and Professional Service Providers.

After the client 122 enters intake data 400 at step 324, the professional services provider 110 is able to export the intake data 400 in a format appropriate for printing, or in an export format appropriate for syncing with computer programs utilized by the professional 110. This occurs at step 332 in process 300. Frequently, the client 122 has hired the professional 110 to generate documents that may themselves be important additions to the client's digital profile 250. In one embodiment, the professional 110 is given the ability through their interface 280 (at step 334) to submit digital versions of these documents to the digital profile 250 of her client 122.

The professional 110 has the ability to receive activity reports for her client 122. These reports will inform the professional services provider of the last time the client 122 has accessed the system 100. In a preferred embodiment of the invention, the professional 110 will also receive activity reports informing the professional 110 of significant changes or shortcomings in client information, either in the intake form 400 or in the remainder of the digital profile 250 that may impact the provider's service offerings.

At step 340, the system 100 prompts the professional 110 to maintain regular e-mail contact with each of her clients 122. The e-mail communication between the professional 110 and her client 122 can take place outside the computerized system 100. In the preferred embodiment, however, the e-mail communications are managed and tracked by the system 100 so that the professional 110 has a consistent and complete record of communications with client 122 concerning the system 100. In fact, the communications can be fully generated and automated by the system 100 so that no additional steps are necessary for the professional 110 to send the communications. In other embodiments, the system 100 will suggest e-mail text based on standard language suggested by the system 100. The professional 110 will have the opportunity to customize the suggested email communication language proposed by the system 100. In some cases, the system 100 will not send any communication until authorized by the professional 110. In this way, the system 100 ensures that the client 122 will receive regular email from his professional services provider 110. In still other embodiments, the professional 110 can modify the level of communication desired with her customer 122. This level of communication can vary from absolutely no ongoing email communication, to correspondence on a regularly scheduled time basis, to ad hoc email or email notice when the digital profile 250 needs attention for some reason.

These email communications serve multiple purposes including:
asking the client 122 to complete or update specific portions of his digital profile 250;
reminding the client 122 to keep his information up-to-date;
providing the client 122 with relevant information related to the service offerings of the professional 110; and
advising the client 122 if an information recipient 130 has failed to register or keep contact information current.

Every recipient 130 who registers himself through the recipient interface 284 at the request of the client 122 becomes a member of that client's network. Recipient 130 will also receive regular email from the professional service provider 110 currently working with that client 122. These emails serve multiple purposes including:
reminding the recipient 130 that he or she has been selected by the client 122 to receive important client information;
reminding the recipient 130 to keep his or her contact information up-to-date;
requesting the recipient 130 to inform the professional service provider 110 about the occurrence of a triggering event; and
indirectly informing the recipient 130 of the services offered by the professional service provider 110.
   As was the case with e-mail communication with the client 122, the professional services provider 110 will have the opportunity to customize the standard content and frequency of email communication with the recipients 130, 132.
   Information Sharing with Recipients.

By maintaining ongoing communication with the client 122 and each of the client's recipients 130, the professional 110 will be able to improve her relationship with client 122 and develop a relationship with each recipient 130. This strengthened relationship will allow the professional 110 to increase their ability to market services to those individuals 122, 130. More importantly, however, regular communication concerning this system 100 will increase the likelihood that the professional 110 will receive timely notification of a triggering event. In many cases, the triggering event will be the death of the client 122, and the communication of that event will come from the recipient 130.

Upon receiving notice of and confirming a triggering event such as the client's disability or death (step 342), the professional 110 verifies the occurrence of that event, and then inputs the event into the system 100 through the professional interface 280 at step 344. Upon verification of the triggering event by the professional 110, the system 100 sends an email notice (step 346) to each recipient 130 identified by the client 122. This email serves only as an invitation to the recipients 130 to visit their recipient interface 284 of the system 100 in order to view client information designated for the recipient. The emails do not contain any client information stored in the digital profile 250.

The recipient 130 will then log into the system 100 at step 348 using the password she established when she confirmed their status as recipients in the client's network at step 330. In the event the recipient 130 has forgotten her password, she is able to retrieve the password by correctly answering the security questions that were established during registration. After logging into the system 100, recipient 130 will receive read-only access to that portion of the client's digital profile 250 designated for their viewing (step 350). The level of access to the profile 250 that will be granted will be as specified by the client 122.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computerized method for sharing information concerning a client working with a professional, the information being shared with a first recipient upon the occurrence of a triggering event, the method comprising:
a) establishing login credentials at a server computer for the client, the professional, and the first recipient;
b) receiving information at the server computer from the client after receiving the login credentials of the client;
c) receiving notification of the triggering event at the server computer from the professional after receiving the login credentials of the professional;
d) sending from the server computer a notification of the triggering event and the existence of the information to a contact address for the first recipient after the server computer receives notification of the triggering event; and
e) sharing, through the server computer, the information with the first recipient after notification of the triggering event and after receiving the login credentials of the first recipient.

2. The method of claim 1, wherein the server computer receives the contact address for the recipient from the client after receiving the login credentials of the client.

3. The method of claim 1, wherein
i) the server computer establishes login credentials for a second recipient,
ii) the server computer sends the notification of the triggering event and the existence of the information to a second recipient contact address after receiving notification of the triggering event,
iii) the server computer shares the information with the second recipient after notification of the triggering event and after receiving the login credentials of the second recipient.

4. The method of claim 3, wherein the information contains a first part and a second part, and the first part of the information is shared with the first recipient but not the second recipient, and further wherein the second part of the information is shared with the second recipient but not the first recipient.

5. The method of claim 4, wherein the server computer receives, along with the information from the client, instructions from the client that the first recipient should receive the first part and that the second recipient should receive the second part.

6. The method of claim 1, wherein the server computer receives from the professional a document after receiving the login credentials of the professional.

7. The method of claim 6, wherein the server computer shares the document with the first recipient after notification of the triggering event and after receiving the login credentials of the first recipient.

8. The method of claim 7, wherein the document is an estate planning document.

9. The method of claim 7, wherein
i) the server computer receives intake information from the client relevant to the generation of the document, and
ii) the server computer shares intake information received from the client with the professional after receiving the login credentials of the professional.

10. The method of claim 1, wherein the information is confidential information.

11. A computerized system for sharing information concerning a client working with a professional, the information being shared with a first recipient upon the occurrence of a triggering event, the system comprising:
a) a processor for executing software instructions;
b) a non-volatile memory for storing software instructions for execution on the processor; and
c) wherein the software instructions cause the processor to perform the following programming steps:
i) establish login credentials for the client, the professional, and the first recipient,
ii) receive information from the client after receiving the login credentials of the client,
iii) receive notification of the triggering event from the professional after receiving the login credentials of the professional,
iv) send a notification of the triggering event and the existence of the information to a contact address for the first recipient after the server computer receives notification of the triggering event, and
v) share the information with the first recipient after notification of the triggering event and after receiving the login credentials of the first recipient.

12. A computerized system for storing information that a client wishes to share with a recipient upon the occurrence of a triggering event, the system comprising:
a) a processor for executing software instructions;
b) a non-volatile memory for storing:
i) a database, the database having data constructs for clients, professionals, recipients, and digital profiles, wherein the digital profile construct includes the information, and
ii) software instructions for execution on the processor;
c) wherein the software instructions cause the processor to perform the following programming steps:
i) establish relationships in the database linking a first client construct with a first professional construct, linking the first client construct with a first recipient construct, and linking the first client construct with a first digital profile construct;
ii) provide a first professional interface to the system associated with the first professional construct in the database,
iii) provide a first client interface to the system associated with the first client construct in the database,
iv) provide a first recipient interface to the system associated with the first recipient construct in the computerized system,
v) provide the ability only through the first client interface to input the information into the first digital profile construct,
vi) provide the ability only through the first professional interface to verify the occurrence of the triggering event, and
vii) reveal the information through the first recipient interface but not through the first professional interface, wherein the information is revealed only after the first professional interface has verified the occurrence of the triggering event.
